(19) United States
(12) Patent Application Publication
(10) Pub. No.: US 2012/0033093 A1
(43) Pub. Date: Feb. 9, 2012

(54) IMAGE STABILIZER CONTROL DEVICE

(75) Inventor: PING-HAN KU, Tu-Cheng (TW)

(73) Assignee: HON HAI PRECISION INDUSTRY CO., LTD., Tu-Cheng (TW)

(21) Appl. No.: 12/890,702

(22) Filed: Sep. 26, 2010

(30) Foreign Application Priority Data
Aug. 6, 2010 (TW) 99126173

(51) Int. Cl. H04N 5/225

(52) U.S. Cl. 348/208.2; 348/E05.024

(57) ABSTRACT

An image stabilizer control device includes a biaxial gyroscope, a processing unit and an actuator unit. The biaxial gyroscope senses movement of an imaging module and detects a first angular velocity of the imaging module in two reference planes perpendicular to each other. The processing unit generates a first driving signal in response to the first angular velocity. The actuator unit moves the imaging module to compensate the movement in response to the first driving signal. The biaxial gyroscope detects a second angular velocity of the imaging module in the two reference planes upon completing movement compensation associated with the first driving signal. The processing unit converts the second angular velocity into a second angle, compares the second angle with a predetermined angle range and generates a second driving signal in response to the comparison result. The actuator unit moves the imaging module in response to the second driving signal.

### BACKGROUND

1. Technical Field

The present disclosure relates to image stabilizer control devices.

2. Description of Related Art

An imaging module typically includes an image sensor for converting light into electrical signals. The electrical signals can be processed to form images. If the imaging module experiences vibration or movement during image capturing, the image sensor is likely to form blurred images. Therefore, an image stabilizer is employed to compensate for the vibration or movement of the image sensor. However, compensation precision of the image stabilizer is unsatisfactory.

Therefore, an image stabilizer control device, which can overcome the above-mentioned problems, is needed.

### BRIEF DESCRIPTION OF THE DRAWINGS

FIG. 1 is a functional block diagram of an image stabilizer control device, according to an exemplary embodiment.

FIG. 2 is a schematic view of the image stabilizer control device of FIG. 1 used in an exemplary imaging module, showing the imaging module in a still state.

FIG. 3 is similar to FIG. 2, but showing the imaging module in a shaked state.

### DETAILED DESCRIPTION

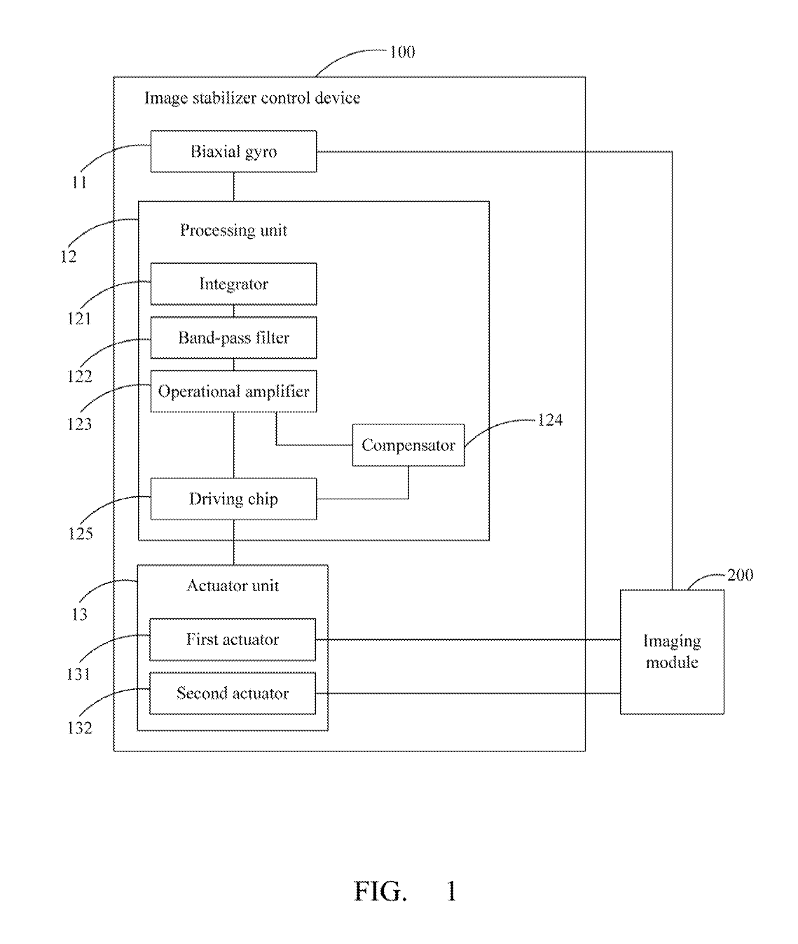

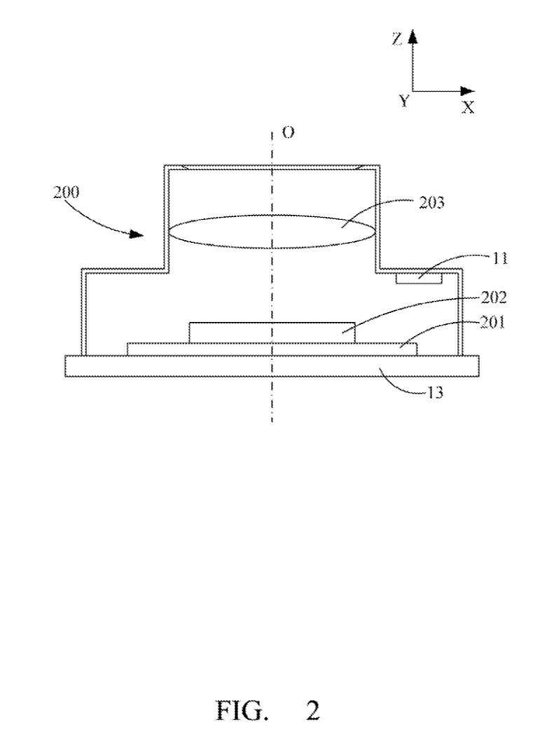

Referring to FIGS. 1 and 2, an image stabilizer control device 100, according to an exemplary embodiment, includes a biaxial gyroscope 11, a processing unit 12, and an actuator unit 13. The control device 100 is used in an imaging module 200. The imaging module 200 includes a base 201, an image sensor 202, and a lens module 203. The image sensor 202 and the lens module 203 are mounted to the base 201. The image sensor 202 is located at the image side of the lens module 203. The lens module 203 has an optical axis O, which is the optical axis of the imaging module 200.

The biaxial gyroscope 11 is electrically connected to the processing unit 12 and is configured for sensing movement of the imaging module 200 caused by shake and detecting a first angular velocity in two reference planes. The two reference planes are perpendicular to each other. When the imaging module 200 is in a still state (see FIG. 2), the two reference planes are an X-Z plane and a Y-Z plane both parallel to the optical axis O in an X-Y-Z coordinate system. The Z axis of the X-Y-Z coordinate system is parallel to the optical axis O, and the X, Y axes are perpendicular to the optical axis O when the imaging module 200 is in the still state. When the imaging module 200 experiences movement, such as from vibration/shake, the biaxial gyroscope 11 detects a first deviation angular velocity along a first direction, and a second deviation angular velocity along a second direction. That is, the first angular velocity includes the first deviation angular velocity and the second deviation angular velocity. The first direction is a direction of the imaging module 200 rotating about the Y axis in the X-Z plane, i.e., a yaw direction. The second direction is a direction of the imaging module 200 rotating about the X axis in the Y-Z plane, i.e., a pitch direction.

The processing unit 12 is configured for generating a first driving signal in response to the first angular velocity.

In this embodiment, the processing unit 12 includes an integrator 121, a band-pass filter 122, an operational amplifier 123, a compensator 124, and a driving chip 125. The integrator 121 is electrically connected to the biaxial gyroscope 11 and the band-pass filter 122. The operational amplifier 123 is electrically connected to the band-pass filter 122 and the driving chip 125. The compensator 124 is electrically connected to the operational amplifier 123 and the driving chip 125. The driving chip 125 includes a pulse width modulation power driving chip.

The integrator 121 is a double integrator. The first angular velocity is processed by the integrator 121, the band-pass filter 122, and the operational amplifier 123 to be converted into a first angle. The first angle includes a first deviation angle and a second deviation angle. The driving chip 125 generates the first driving signal in response to the first angle.

The actuator unit 13 is electrically connected to the driving chip 125 of the processing unit 12 and is configured for moving the imaging module 200 to compensate the movement of the imaging module 200 in response to the first driving signal.

The actuator unit 13 includes a first actuator 131 and a second actuator 132. The first actuator 131 is configured for moving the imaging module 200 in one of the two reference planes, such as the X-Z plane. The second actuator 132 is configured for moving the imaging module 200 in the other one of the two reference planes, such as the Y-Z plane. The first and second actuators 131, 132 may be piezoelectric actuators, surface acoustic wave actuators, or other suitable actuators.

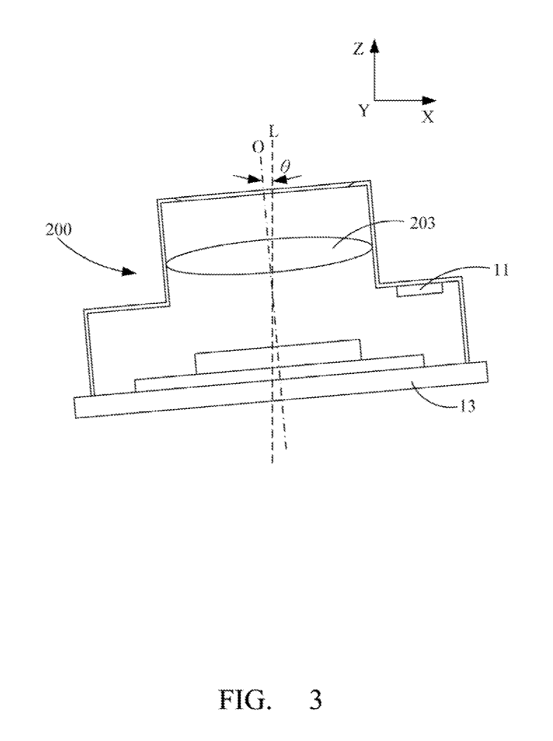

The biaxial gyroscope 11 is configured for detecting a second angular velocity in the two reference planes upon completing the movement compensation associated with the first driving signal. The processing unit 12 is configured for converting the second angular velocity into a second angle and comparing the second angle with a predetermine angle range and generating a second driving signal in response to the comparison result. Specifically, the compensator 124 compares the second angle with a predetermine angle range and generates the second driving signal in response to the comparison result. The actuator unit 13 moves the imaging module 200 in response to the second driving signal. The predetermined angle range includes a first angle range along the first direction and a second angle range along the second direction. The first angle range is defined as a range of an included angle between the Z axis (also indicated as the dashed line L in FIG. 3) and the optical axis O along the first direction. For example, the first angle range may be [0, 0.05] degrees. The second angle range is defined as a range of an included angle between the Z axis and the optical axis O along the second direction. For example, the second angle range may be [0, 0.05] degrees.

Referring to FIG. 3, when the imaging module 200 experiences vibration/shake, the optical axis O of the lens module 203 is deviated counterclockwise from its original position L by an angle θ about the Y axis in the X-Z plane. The optical axis O at its original position L is parallel to the Z axis. Under this circumstance, the biaxial gyroscope 11 detects the first angular velocity of the imaging module 200. The processing unit 12 converts the first angular velocity into a first angle θ1 and controls the actuator unit 13 to move the imaging module 200 to rotate clockwise about the Y axis by the first angle θ1.

When the above movement compensation of the imaging module 200 associated with the first driving signal is completed, the biaxial gyroscope 11 further detects a second angular velocity of the imaging module 200. The processing unit 12 converts the second angular velocity into a second angle θ2 and compares the second angle θ2 with the predetermined angle range [0, 0.05] degrees. If 0°≦θ2≦0.05°, the processing unit 12 generates a null signal to idle the actuator unit 13. If θ2>0.05°, the processing unit 12 generates a driving signal to activate the actuator unit 13 to move the imaging module 200 until the second angle θ2 is within the predetermined angle range [0, 0.05] degrees. Therefore, movement compensation of the imaging module 200 can be satisfactory.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An image stabilizer control device for compensating movement of an imaging module caused by shake, comprising:
a biaxial gyroscope configured for sensing movement of the imaging module caused by shake and detecting a first angular velocity of the imaging module in two reference planes, the reference planes being perpendicular to each other;
a processing unit configured for generating a first driving signal in response to the first angular velocity; and
an actuator unit configured for moving the imaging module to compensate the movement in response to the first driving signal, the biaxial gyroscope configured for detecting a second angular velocity of the imaging module in the two reference planes upon completing the movement compensation associated with the first driving signal, the processing unit configured for converting the second angular velocity into a second angle, comparing the second angle with a predetermined angle range and generating a second driving signal in response to the comparison result, the actuator unit configured for moving the imaging module in response to the second driving signal.

2. The control device of claim 1, wherein the processing unit comprises a double integrator electrically connected to the biaxial gyroscope for converting the first angular velocity into a first angle and converting the second angular velocity into the second angle.

3. The control device of claim 2, wherein the processing unit further comprises a compensator configured for comparing the second angle with the predetermined angle range and generating the second driving signal in response to the comparison result.

4. The control device of claim 2, wherein the driving chip comprises a pulse width modulation power driving chip.

5. The control device of claim 1, wherein the actuator unit comprises a first actuator and a second actuator, the first actuator being configured for moving the imaging module in one of the two reference planes, the second actuator being configured for moving the imaging module in the other one of the two reference planes.

6. The control device of claim 5, wherein the first actuator is a piezoelectric actuator or a surface acoustic wave actuator.

7. The control device of claim 6, wherein the second actuator is a piezoelectric actuator or a surface acoustic wave actuator.
